(19) United States
(12) Patent Application Publication
(10) Pub. No.: US 2023/0019652 A1
(43) Pub. Date: Jan. 19, 2023

(54) SYSTEM AND METHOD FOR VIDEO CONFERENCE WITH COUPLED REAL-TIME DOCUMENT EDITING AND SIGNING

(71) Applicant: ProVideoMeeting.com, Inc., Philadelphia, PA (US)

(72) Inventors: Vito Lomonaco, Cresco, PA (US); Craig Waldrep, Gilbert, AZ (US)

(21) Appl. No.: 17/724,190

(22) Filed: Apr. 19, 2022

Related U.S. Application Data
(60) Provisional application No. 63/177,195, filed on Apr. 20, 2021.

(51) Int. Cl. G06F 3/14; G06F 40/171; H04L 12/18; G06Q 50/18

(52) U.S. Cl. CPC G06F 3/1454; G06F 40/171; H04L 12/1813; G06Q 50/18

(57) ABSTRACT

A method for conducting a video conference includes providing a platform supporting a video conference between a plurality of participants, the plurality of participants engaging in a video conference thereon. Within the video conference, controls are provided to at least one of the participants to upload a document to be signed, the uploaded document viewable by all of the participants. Each of the participants in the video conference may independently control their view of the document.

### RELATED APPLICATION

This application claims the benefit of priority from U.S. Provisional Application No. 63/177,195, filed on Apr. 20, 2021, the entirety of which is incorporated by reference.

### FIELD OF THE INVENTION

The present invention relates to the field of video conferencing. More particularly, the present invention relates to the field of video conferencing with coupled document editing and signing features.

### DESCRIPTION OF PRIOR ART

In the field of video conferencing there are often situations in the business and legal world where part of the conference activities includes the need to have documents reviewed, witnessed, and executed. Currently, there are many video conferencing software/applications available that enable live video conferencing. However, none of these prior art video conferencing systems include full document signing capabilities within the active video conference. In the prior art when such a situation arises, the participants usually must engage with an external document signing program/application through an API, but the signing itself is not viewable within the context of the live conference. For example, participants in prior art live video conferences that need to sign a document typically open a separate application and conduct the e-signing procedure outside of the video conference, with possible separate email confirmations, before they return to the conference.

### OBJECTS AND SUMMARY

The present arrangement overcomes the drawbacks associated with the prior art and provides a video conference experience with an integrated document signing feature that does not require an additional or external document signing applications/programs. This allows participants to upload documents for signature directly within a video conference through a document signing feature, and to view, mark, and highlight sections for discussion, as well as witness the signatures in real time, with associated signature verification tools for generating a record thereof.

To this end the present arrangement provides a method for conducting a video conference. The method includes providing a platform supporting a video conference between a plurality of participants, the plurality of participants engaging in a video conference thereon. Within the video conference, controls are provided to at least one of the participants to upload a document to be signed, the uploaded document viewable by all of the participants. Each of the participants in the video conference may independently control their view of the document.

Within the video conference, controls are provided to the at least one participant that uploaded the document to be signed allowing the at least one participant to assign one or more participants as signatories of the document. Within the video conference, controls are provided to at least the at least one participant that uploaded the document to be signed allowing the at least one participant to generate one or more markable locations on the uploaded document to be marked by the signatories.

Controls are provided to each of the participants assigned as signatories the ability to mark the document at at least one generated markable location. Controls are provided to the at least one participant that uploaded the document to be signed to accept signatures of the participants assigned as signatories. Controls are provided to allow the participant that uploaded the document to close the marked uploaded document and return all participants to the video conference.

### BRIEF DESCRIPTION OF THE DRAWINGS:

The present invention can be best understood through the following description and accompanying drawings, wherein:

FIG. 1 is an overview system diagram for the present video conferencing and document signing system, in accordance with one embodiment;

FIG. 2 is a screen shot of a meeting room screen in accordance with one embodiment;

FIG. 3a is a screen shot of an upload document screen in accordance with one embodiment;

FIG. 3b is a screen shot of a select document screen in accordance with one embodiment;

FIG. 3c is a screen shot of a file conversion screen in accordance with one embodiment;

FIG. 4 is a screen shot of a document and signing controls screen in accordance with one embodiment;

FIG. 5 is a screen shot of a signers page screen in accordance with one embodiment;

FIG. 6 is a screen shot of a field and signer assignment screen in accordance with one embodiment;

FIG. 7 is a screen shot of a placed fields screen in accordance with one embodiment;

FIG. 8 is a screen shot of a terms and conditions screen in accordance with one embodiment;

FIG. 9 is a screen shot of a verification choices screen in accordance with one embodiment;

FIGS. 10 and 10.1 are screen shots of SMS verification screens(s) in accordance with one embodiment;

FIGS. 11 and 11.1 are screen shots of snapshot verification screen in accordance with one embodiment;

FIG. 12 is a screen shot of an accept or decline snapshot screen in accordance with one embodiment;

FIGS. 13 and 13.1 are screen shots of name field screens(s) in accordance with one embodiment;

FIG. 14 is a screen shot of a text field screen in accordance with one embodiment;

FIGS. 15 and 15.1 are screen shots of date field screen(s) in accordance with one embodiment;

FIGS. 16, 16.1, and 16.2 are screen shots of signature field screen(s) in accordance with one embodiment;

FIG. 17 is a screen shot of an initials field screen in accordance with one embodiment;

FIG. 18 is a screen shot of a signing process and history screen in accordance with one embodiment;

FIG. 19a is a screen shot of a review stage screen in accordance with one embodiment.

FIG. 19b is a screen shot of an accept or reject screen in accordance with one embodiment;

FIG. 20a is a screen shot of a finish or continue screen in accordance with one embodiment;

FIG. 20b is a screen shot of a confirm finish screen in accordance with one embodiment;

FIG. 21 is a screen shot of signing process complete screen in accordance with one embodiment;

FIG. 21.1 is a screen shot of send via email screen in accordance with one embodiment;

FIG. 22a is a screen shot of a summary document-verification screen in accordance with one embodiment;

FIG. 22b is a screen shot of a summary document-completed fields screen in accordance with one embodiment; and

FIGS. 23 and 23.1 are screen shots of attention tool screens(s) in accordance with one embodiment.

### DETAILED DESCRIPTION:

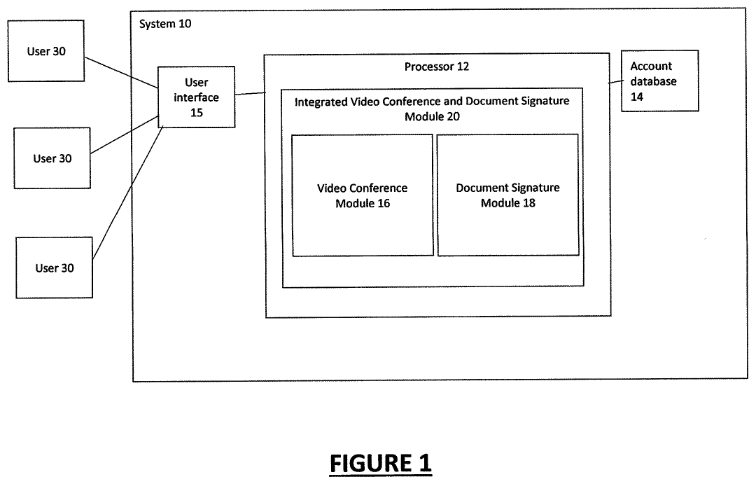

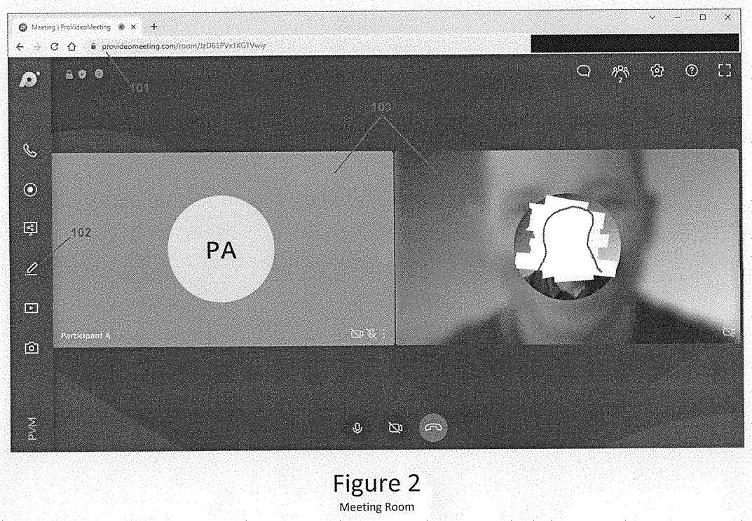

In accordance with one embodiment of the invention, FIG. 1 illustrates a block diagram of video conference system with an included document signing mode (system 10) as well as the functional modules therein. As shown in FIG. 1, system 10 includes a processor 12, an account database 14, and communication module 15 for connection with the internet. Processor 12 supports at least two modules, a first module 16 of which is a module for processing video conference sessions for any one of a plurality of users 30 of system 10 and/or account holders with accounts in account database 14. Processor 12 also supports a second document signing module 18 for processing document signing in conjunction with first video processing module 16 in an integrated manner as discussed in more detail below. As shown in FIG. 1, first video processing module 16 and second document signing module 18 are independent (and may also operate as independent functional platforms in some applications), but both are contained with a combined integrated video document module 20 that allows interoperability of the two. The full details of such interoperation of modules 16 and 18 within combined integrated video document module 20 is explained in the various screen shot and flow documentation beginning with FIG. 2.

It is understood that FIG. 1 is only shown as an exemplary diagram of some primary functional modules of system 10, that may be implemented as either hardware or software solutions or combinations thereof. Additional modules may be added or sub-divided into additional functions within system 10 as required to handle the salient features of the combined document signing and video conferencing features described below.

Turning to an exemplary embodiment of at least two users 30, connecting through system 10 in a video conference and engaging the integrated document signing features, the following screen shots and accompanying descriptions set forth certain non-limiting salient features of such system and related method.

In one aspect of the present arrangement FIG. 2 is a screen shot of a meeting room. Here FIG. 2. shows a browser window (address bar) 101 for a video collaboration software where an integrated document signing feature button 102 is launchable between participants 103 shown in their respective video conferencing windows. As illustrated in the next slides, document signing feature 102 is launched directly within an active video collaboration window 101 using its associated button without the need for launching external/second independent programs or applications. Such features and functions may be supported for example by integrated video conference and document signing module 20 of system 10 as discussed above.

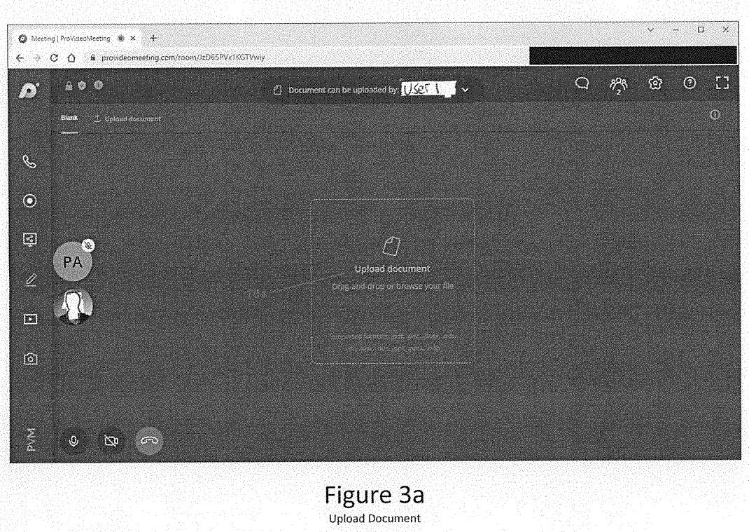

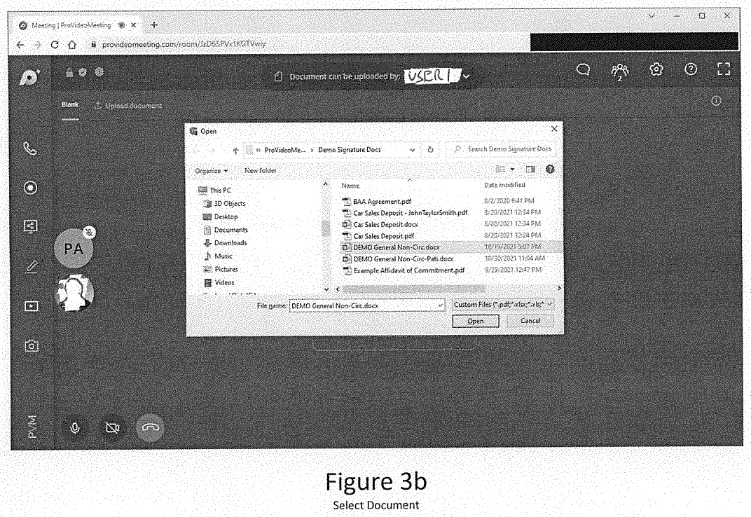

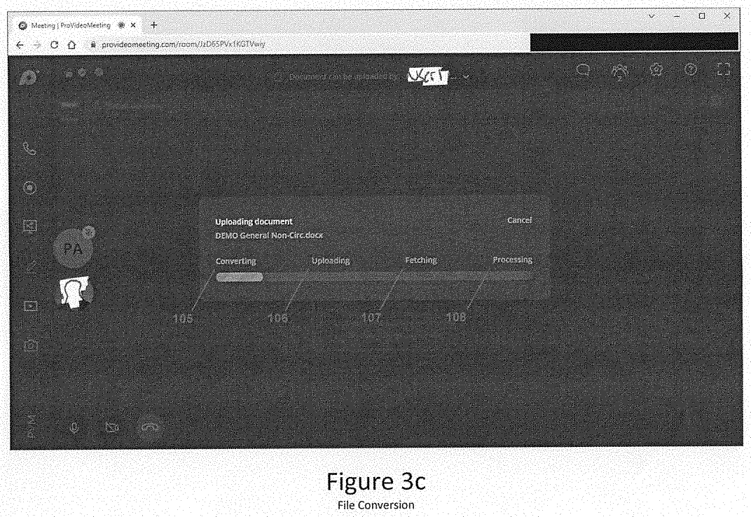

In one aspect of the present arrangement FIG. 3a is a screen shot of showing the activation of document signing feature 102 in the context of uploading document. Here FIG. 3a shows how document signing feature 102 appears for the first time to participants 103. After activation of the button associated with document signing feature 102, display 104 is provided where the document owner/participant 103 can drag-and-drop or browse a file to be signed from their local storage device on their PC or other available file access points. FIG. 3b is a screen shot of a select document screen that shows a folder window of, for example, a local storage device to choose a file for uploading. FIG. 3c is a screen shot of a file conversion screen (timer) that shows the completion stages of the process taken when a selected file begins to convert 105, upload 106, fetch 107, and process 108 before being displayed to meeting participants 103.

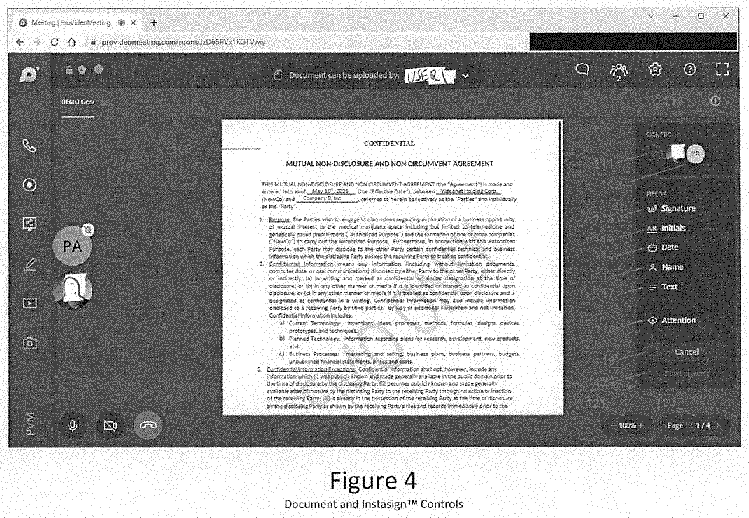

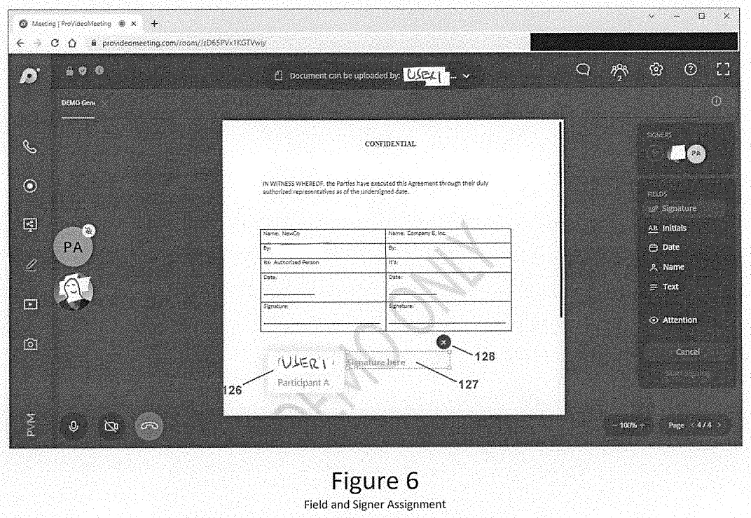

In one aspect of the present arrangement FIG. 4 is a screen shot of a document and signing controls screen. Here FIG. 4. shows an uploaded document ready for signing now occupying the video conference windows of the participants 103. Document 109 is the uploaded document, beginning with the first page. All participants can zoom in or out 121 and switch between pages 123 using such functional buttons. A clickable icon 110 enables or disable help tips, which appears by default if it is the signer's first time using the present document signing feature 102. Item 112 indicates the selected signers from participants 103 of the meeting. A signing participant 103 must be selected as a signer by the uploader or document 109 to become an assignable choice for fields as seen in later described FIG. 6. Fields 113-117 can be placed onto the document by the document owner. Field 113 is used by a participant 103 to place a signature field onto document 109. Field 114 can be used to place an initials field onto document 109. Field 115 can be used to place a date field onto document 109. Field 116 can be used to place a name field onto document 109. Field 117 can be used to place a text field onto document 109. Such fields can be placed on document 109 by participant 103 that uploaded or by other participants 103 that are authorized by the uploader. The full features and workflow of what happens when a participant 103 that uploads a document 109 implements such signer activation field functions 113-117 is described in more detail below.

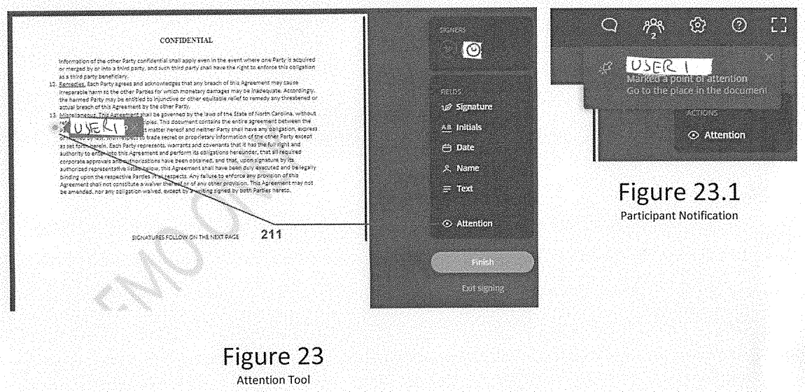

Button 118 is an attention tool made available to all participants, the function of which is described further in FIGS. 23 and 23.1. Button 119 can be used by participants 103 to cancel the current signing session. Button 120 to start the signing process only becomes active when at least one field is placed on the document, ready for signing.

It is noted that each of participants 103 selected by the uploader of document 109 can view the entirety of document 109 independent from one another. In other words, integrated video document module 20 and associated document signing feature 102 allows each of participants to scroll through, page turn, enlarge, and otherwise view document 109 in any manner they choose without affecting how the other participants are viewing the same document 109. Thus system 10 and document signing feature 102 is supporting independently viewable but linked copies of the same document 109. There are features described in more detail below where one participant 103 may direct attention on document 109 or otherwise command the views of other participants 103, but in general the viewing features of one participant 103 are independent of other participants 103 within the same document signing feature session 102.

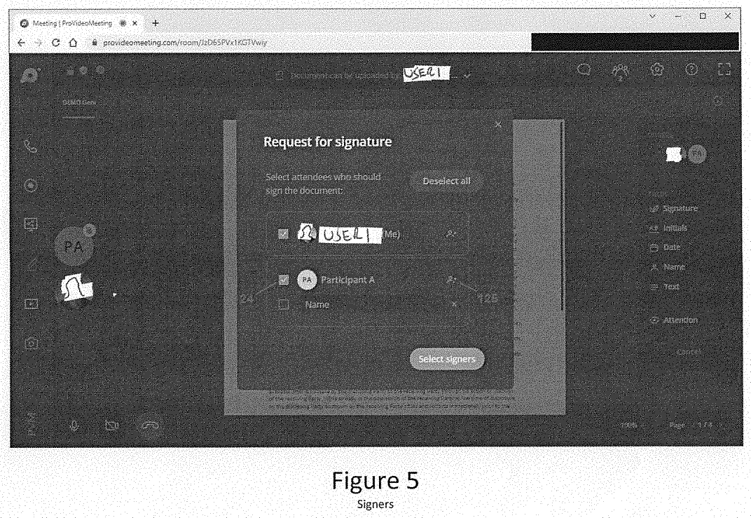

In one aspect of the present arrangement FIG. 5 is a screen shot of a signers screen that shows the window that appears when field 111 (signers) is clicked, per FIG. 4. Signers of document 109 can be selected or deselected by participant 103 that uploaded document 109 with check boxes indicated in field 124, ie the uploading participant 103 can select who among all video conference participants 103 can utilize the signing features. Button 125 is the add sub-signer button. An example of a sub-user is if more than one person/participant 103 is connected to the meeting behind the same PC who also needs to sign the same document 109. The participant 103 that is the document owner can add any number of sub-signers.

In one aspect of the present arrangement FIG. 6 is a screen shot of a field and signer assignment screen. Here FIG. 6. shows what happens when a signature field 113 is clicked from the right fields panel (See FIG. 4). A rectangular signature field 127 appears that can be moved and resized. A choice of participant box 126 appears to the left of field 127. A signer must be selected and assigned to each field 127. Button 128 can be used to remove field 127 from document 109.

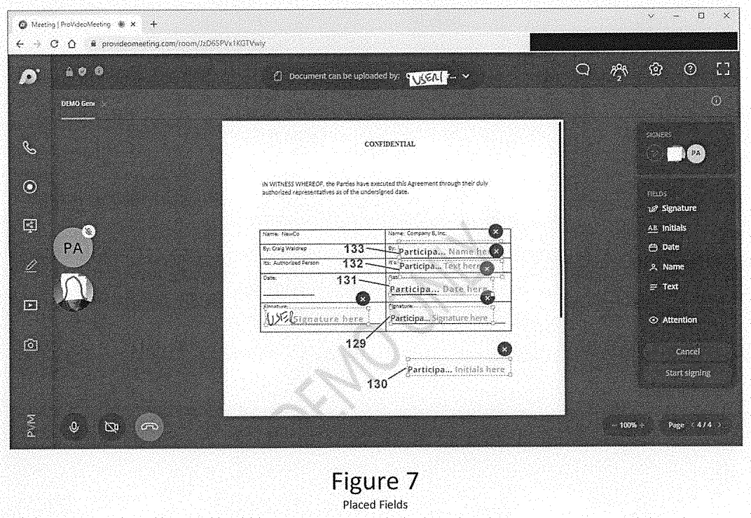

In one aspect of the present arrangement FIG. 7 is a screen shot of several placed fields screen that shows an example of several fields placed onto an exemplary signature page of document 109, where a Participant A is the selected signer. For example, field 129 is a signature field inserted using signature field function 113. Field 130 is an initials field inserted using initials field function 114. Field 131 is a date field inserted using date field function 115. Field 132 is a text field inserted using text field function 117. Field 133 is a name field inserted using name field function 116. (See FIG. 4 for field functions 113-117) Each field can be moved, resized, or removed from document 109 similar to FIG. 6.

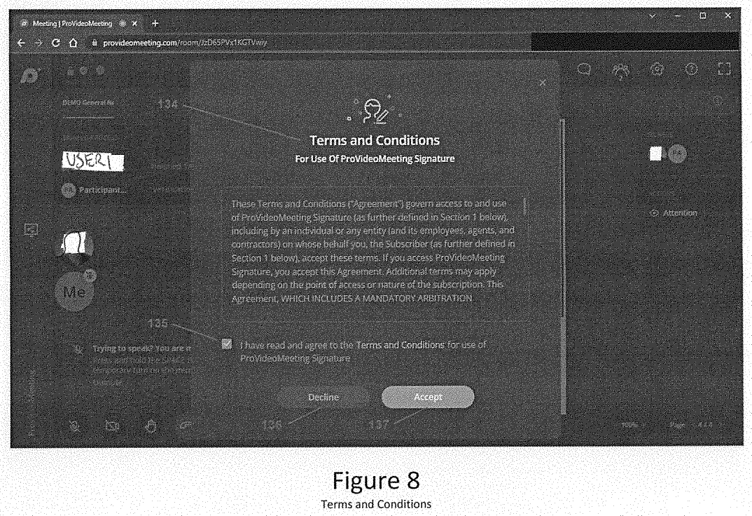

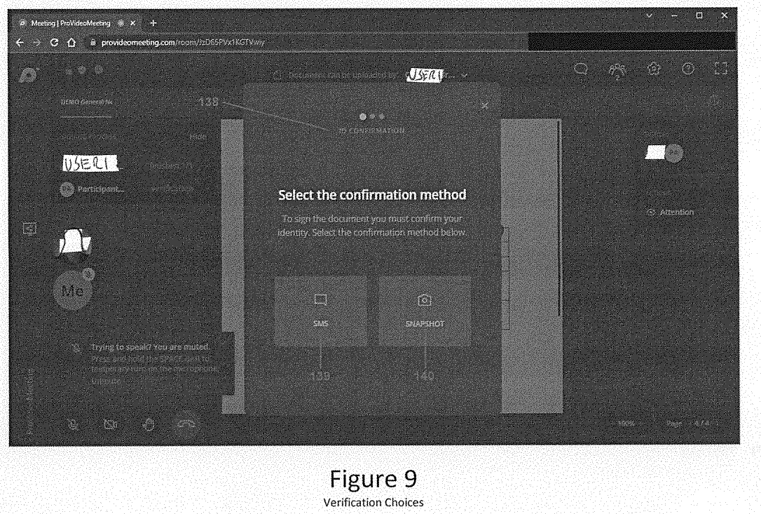

In one aspect of the present arrangement FIG. 8 is a screen shot of a terms and conditions screen that displays the integrated document signing module 20 terms and conditions 134. Signers of document 109 must accept these terms by checking box 135, then clicking an accept button 137. Signers can decline 126 but doing so will immediately stop the signing process for that signer. FIG. 9 is a screen shot of a verification choices screen that shows the verification choices 138 as the next required step after accepting the terms and conditions 134. Signers are given a choice between SMS verification 139 or taking a live picture of themselves with their camera via Snapshot 140.

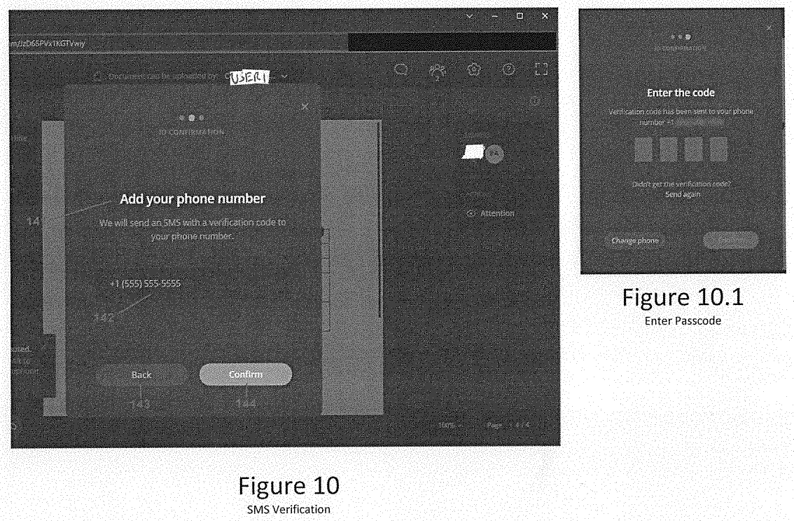

In one aspect of the present arrangement FIGS. 10 and 10.1 are screen shots of SMS verification screens(s) is signing participant selects SMS verification 139. FIG. 10. shows the SMS verification window 141 prompting the signer to enter their cell phone number 142. Clicking the Confirm button 144 sends a unique numerical passcode to the signer's cell phone facilitated through system 10. When the signer receives their unique passcode, they're prompted to enter those digits into the next window as shown in FIG. 10.1. when confirmed, the signer is allowed to move on to the next step. If a passcode is not received, clicking send again will resend a new code to the signer's phone. If the wrong number was entered, the signer can click a change phone button to re-enter their cell phone number. If the signer chooses to change their method of verification, they can choose the Back button 143 to return to FIG. 9.

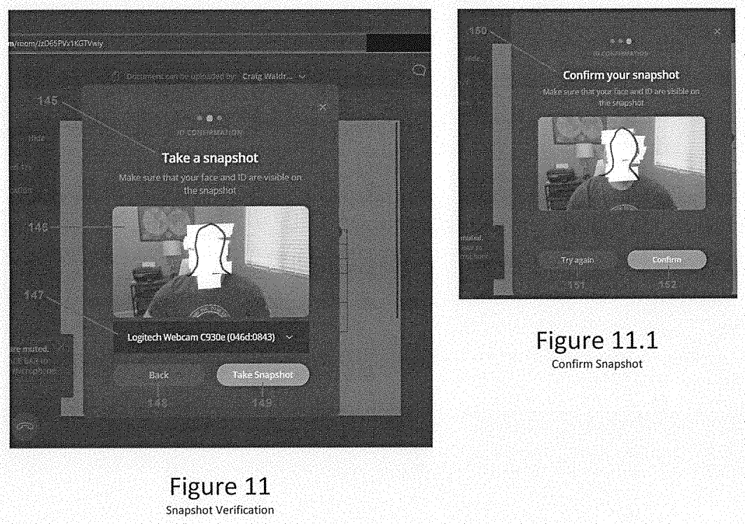

In one aspect of the present arrangement FIGS. 11 and 11.1 are screen shots of snapshot verification screens. FIGS. 11 and 11.1 show the Snapshot window 145. The signer's self-view image is displayed 146 using for example the camera on their device. The signer can choose a different camera 147 if more than one camera is selectable. Clicking the Take Snapshot button 149 will display FIG. 11.1 to Confirm 152 or Retry 151 if the image needs to be retaken. If the signer chooses to change their method of verification, they can choose a Back button 148 to return to FIG. 9.

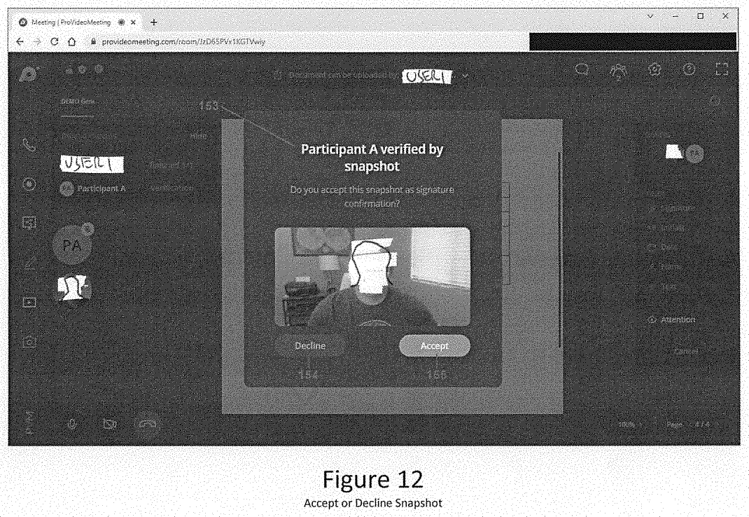

After taking the snapshot in FIGS. 11 and 11.1, at FIG. 12 a screen shot is shown of an accept or decline snapshot screen. Here FIG. 12. shows participant 103 that uploaded document 109 receiving a snapshot 153 sent from a signer. The owner must either accept 155 or decline 154 the image. Accepting the snapshot will allow the signer to continue to the next step in the signing process. Declining the snapshot will require the signer to retake their picture or change their method of verification.

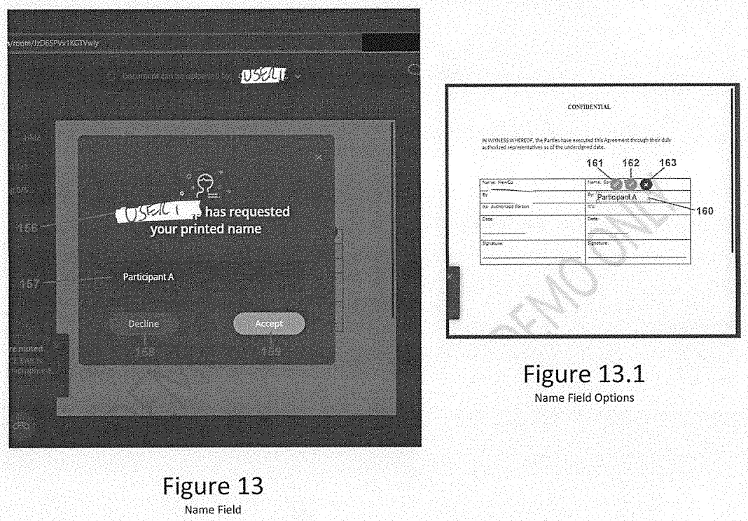

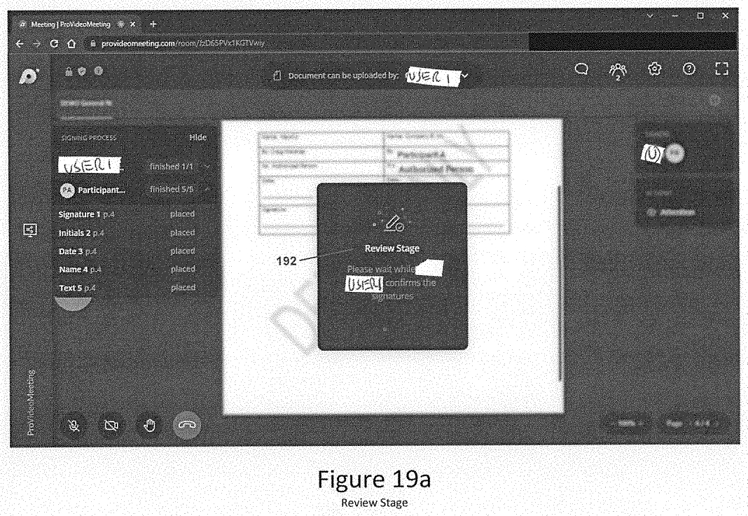

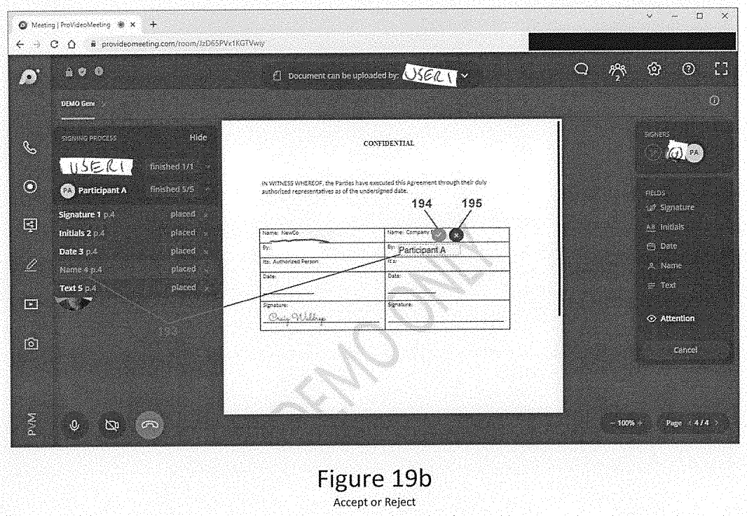

In one aspect of the present arrangement FIGS. 13 and 13.1 are screen shots of name field screens(s) used when name field function 116 is placed by the uploader of document 109 and activated by the signer. FIG. 13. shows the name request window 156 when a signer is requested to place their name on the document. Window 157 populates the signer's display name from the meeting, allowing them to edit the text, if needed. The signer is prompted to choose whether to accept 159 or decline 158 the request to place their name on the document. Accepting will place the name field onto the document as seen in FIG. 13.1 with the named entered in 157 populated. The signer can move or resize the field 160, edit their name 161, accept the changes 162, or decline the name request 163 using such buttons. Declining the name field request will inform uploader of document 109 of the signer's decision during the Review Stage later in FIG. 19a.

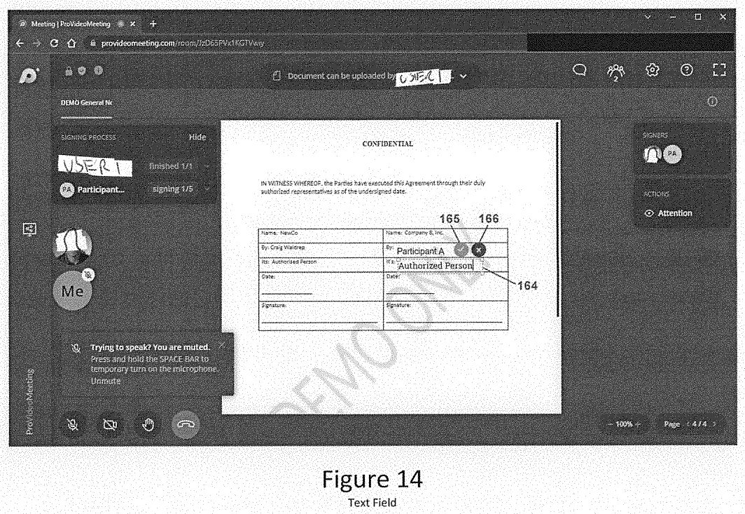

In one aspect of the present arrangement FIG. 14 is a screen shot of a text field screen activated when signing participant 103 activates text field function 117 inserted by the uploading participant 103 of document 109. FIG. 14. shows a text request field 164 placed on document 109. The signer must click into the text field to begin typing characters, as an example, “Authorized Person” was typed into the field as shown in FIG. 13. The signer can move or resize field 164, accept the changes 165, or decline the name request 166 using such buttons. Declining the name field request will inform the document owner of the signer's decision during the Review Stage later in FIG. 19a.

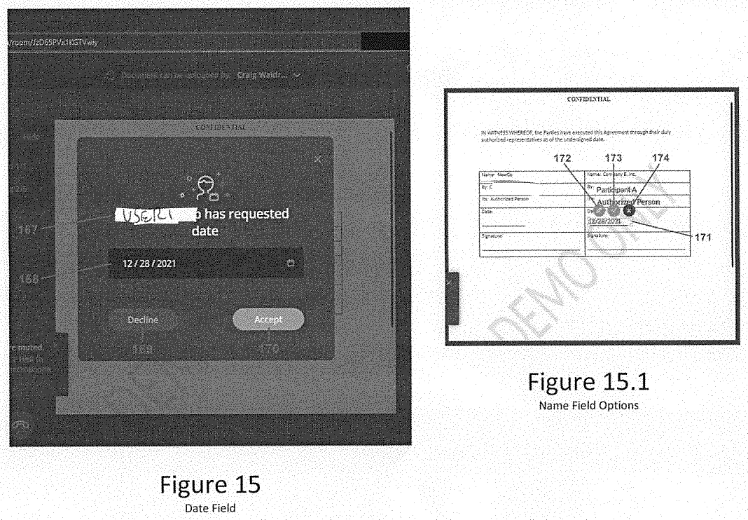

In one aspect of the present arrangement FIGS. 15 and 15.1 are screen shots of date field screens(s) activated when signing participant 103 activates date field function 117 inserted by the uploading participant 103 of document 109. FIG. 15. shows the date request window 167 when a signer is requested to place a date on the document. Window 168 populates today's date, allowing them to edit the date, if needed. The signer is prompted to choose whether to accept 170 or decline 169 the request to place a date. Accepting will place the date field onto the document as seen in FIG. 15.1 with the date entered in 168 populated. The signer can move or resize the field 171, edit the date 172, accept the changes 173, or decline the date request 174 using such buttons. Declining the date field request will inform the document owner of the signer's decision during the Review Stage later in FIG. 19a.

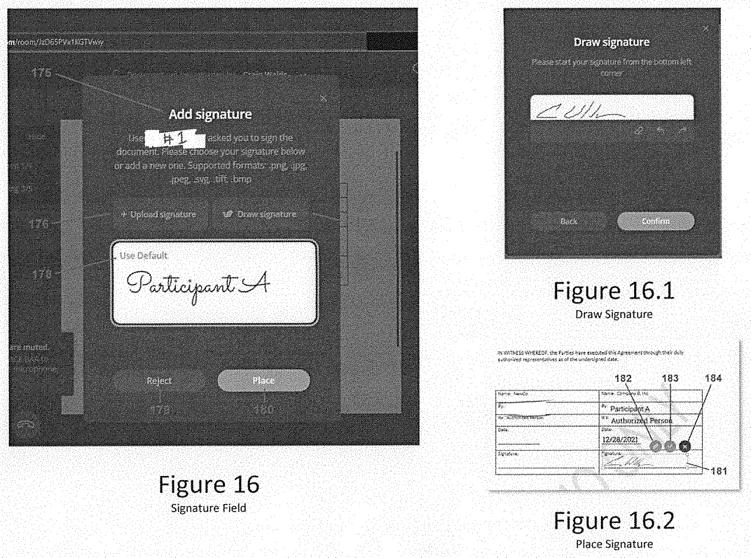

In one aspect of the present arrangement FIGS. 16, 16.1, and 16.2 are screen shots of signature field screens(s) activated when signing participant 103 activates the text field function 117 inserted by the uploading participant 103 of document 109. FIG. 16. shows the signature request window 175 when a signer is requested to place their signature on document 109. The signer can choose to upload an existing signature image using button 176. Clicking upload signature button 176 will prompt the signer to choose an image file from their local storage device on their PC or other accessible storage location. As seen in FIG. 16.1, if the signer chooses to draw their signature using their mouse of touchpad 177, they will see an empty canvas to draw their signature. The signer may also choose to use the default signature button 178 provided by the document signing feature 102. Whichever signature type is selected, the signer must choose whether to place 180 or reject 179 the request to place their signature on the document. Accepting will place the selected signature onto the document as seen in FIG. 16.2. The signer can move or resize the field 181, edit their signature 182, accept the changes 183, or decline the signature request 184 using such buttons. Declining the signature field request will inform the document owner of the signer's decision during the Review Stage later in FIG. 19a.

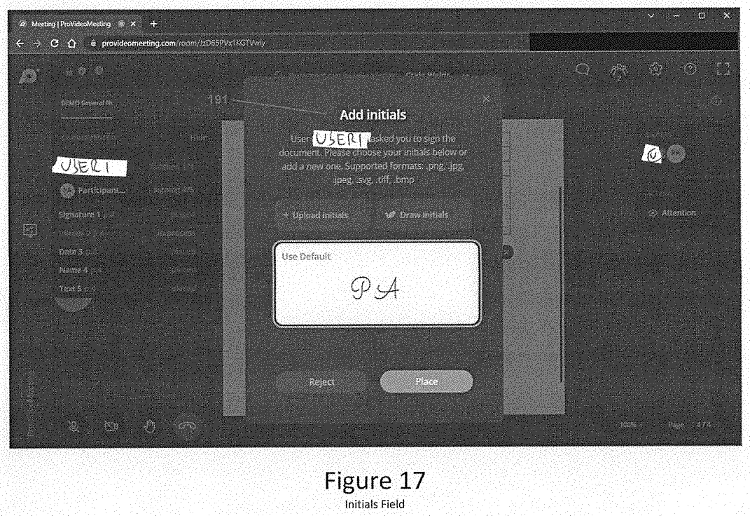

In one aspect of the present arrangement FIG. 17 is a screen shot of an initials field screen activated when signing participant 103 activates the text field function 114 inserted by the uploading participant 103 of document 109. Here FIG. 17. shows the initials request window 191 when a signer is requested to place their initials on the document. The same mechanisms and options were used for the initials request fields as they were for signature request fields, see FIG. 16, FIG. 16.1, and FIG. 16.2.

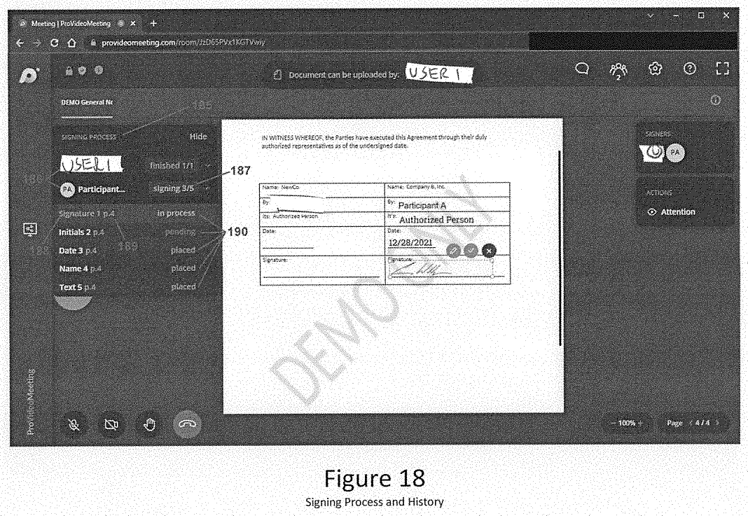

In one aspect of the present arrangement FIG. 18 is a screen shot of a signing process and history screen that shows the signing process menu 185 that displays live reporting of each signer during the signing process. As an example, window 186 shows two signers “User 1” and “Participant A”. Right of their names is a colored column stating their current status. “User 1” finished signing one (1) of one (1) requested signatures, whereas Participant A is still in the process of signing three (3) of five (5) requested signatures. The collapsible arrow to the far right of each signer displays more details about the type of fields that were requested 188, which page on document 109 the signature resides 189, and the status of each field 190.

As noted above all of the viewing of document 109 as well as the entire signature process is viewable in real-time by all viewing participants 103 throughout the entire process.

In one aspect of the present arrangement FIG. 19a is a screen shot of a review stage screen. Here FIG. 19a shows the signing process completed by all signers. Signers are prompted 192 to wait until the owner/uploader of document 109reviews and accepts their signatures. FIG. 19b is a screen shot of an accept or reject screen that shows the signing process completed as seen by the document owner. Participant 103 that is the uploader/power of document 109 is presented with each completed field 193, where they can decide to accept 194 or reject 195 each of them. If accepted, the next field will appear for approval until all completed fields have been reviewed. If any fields are rejected, the owner/uploader of document 109 can request a signing participant 103 to redo a field or remove the field completely from document 109.

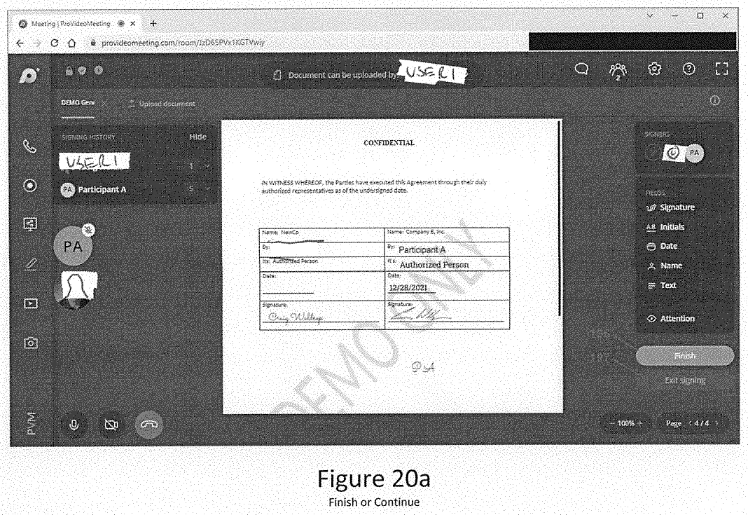

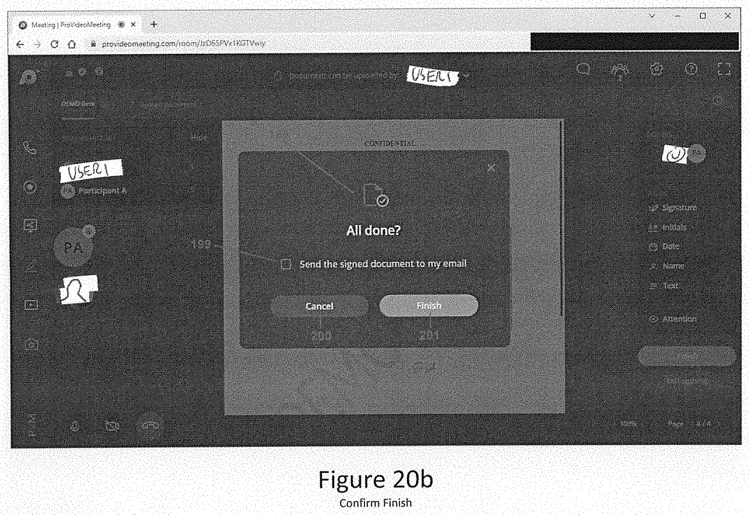

In one aspect of the present arrangement FIG. 20a is a screen shot of a finish or continue screen that is presented to the uploader/owner of document 109 to decide to complete the process and exit document signing feature 102 and return to the primary in-process video conference between participants 103. FIG. 20a. shows a completed signing process screen shot when document 109 is now ready to be finalized. Clicking the finish button 196 will prompt a confirmation window as seen in FIG. 20b. The document owner/participant 103 may decide not to finish the session and continue to place more fields onto document 109 as per the features outlined above. Clicking the exit signing button 197 on the other hand closes integrated document signing feature 102 and return to the normal meeting room 101 as seen in FIG. 2.

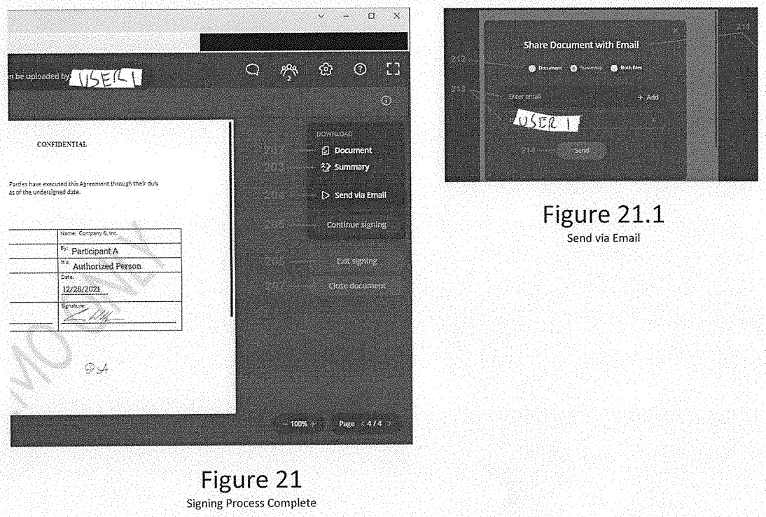

In one aspect of the present arrangement FIG. 20b is a screen shot of a confirm finish screen that shows a confirmation window 198 when a finish button 196 is clicked from FIG. 20a. Checking box 199 will email both signed document and summary files as attachments to the document owner's email address. Clicking finish button 201 will complete the finishing process and proceed to FIG. 21. Clicking cancel 200 closes the confirmation window 198 and returns to document 109 as shown in FIG. 20a.

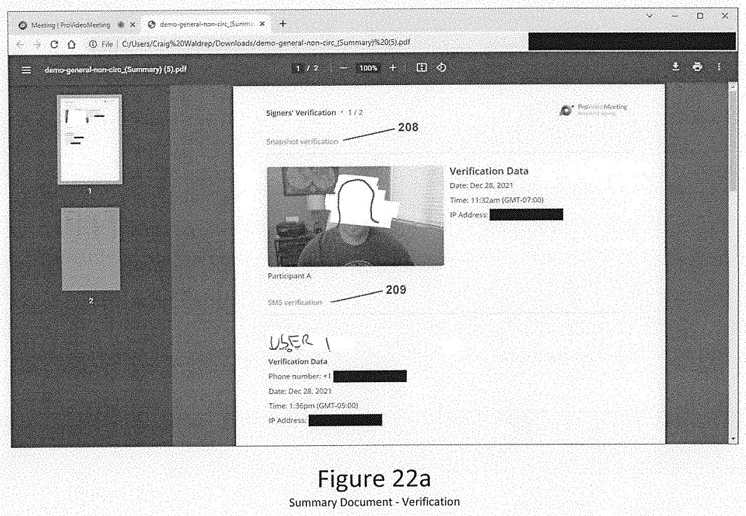

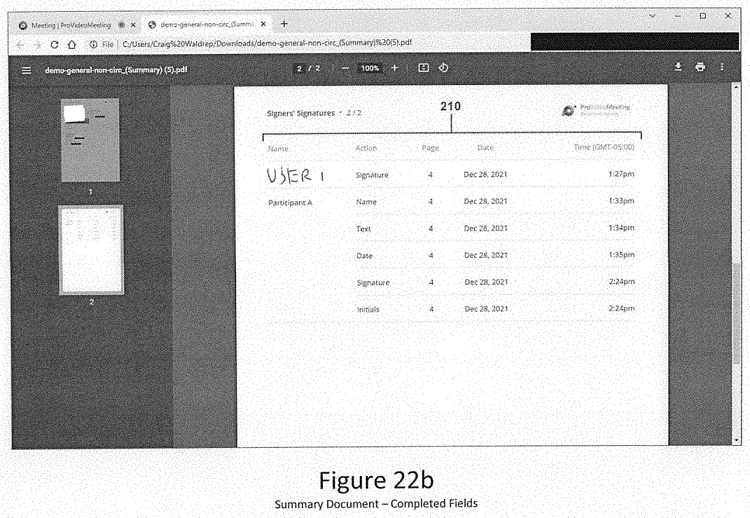

In one aspect of the present arrangement FIG. 21 is a screen shot of signing process complete screen that is presented to owner/uploader of document 109. Here FIG. 21. shows options presented to owner/uploader document 109 owner to download 202 signed document 109, download a summary document 203 as shown in FIG. 22a and FIG. 22b, send these files via email 204, or return to document 109 and continue signing 205 (e.g. edit signing procedure using the tools outlined above. Clicking the exit signing button 206 closes integrated document signing feature 102 and returns to the normal meeting experience of meeting room 101 as seen in FIG. 2. Clicking a close document button 207 removes document 109 entirely from the document signing feature 102, clearing the board for uploading more documents 109 to be signed according to the same process outline above.

In one aspect of the present arrangement FIG. 21.1 is a screen shot of send via email screen that shows the send via email window 211. Document owner/uploader may decide which files to send using buttons 212, enter the email addresses of the recipient(s) in window 213, then click send a send button 214. FIG. 22a is a screen shot of a summary document-verification screen that shows all the verified information collected by each signer, whether by snapshot 208 or SMS 209. Snapshot collects the name, date, time stamp, and IP address of each signer. SMS collects the verified cell number, date, time stamp, and IP Address of each signer. FIG. 22b is a screen shot of a summary document-completed fields screen that shows a list of all completed fields by each signer in window 210. The list may include the name of each signer and their action (completed fields), page where the field(s) were placed, date, and time stamp.

In one aspect of the present arrangement FIGS. 23 and 23.1 are screen shots of an attention tool screens(s). Here FIG. 23 shows the placement of an Attention mark 211 on the document 109. Using the Attention tool is the fastest way for one participant/signer 103 to not only bring other participants 103 onto the same page of document 109 as user of the tool, but also to display exactly where they want other participants'103 eyes to focus as soon as the page loads. This tool allows any participant 103 with permission (possibly all participants 103) to mark a distinct spot on document 109 for other participants 103 to quickly jump to that point of attention. As noted above, each of participants 103 have independent viewing capabilities within the context of document signing feature 102. For example, in some implementations each participant 103 has a cached local copy of document 109 so that each be looking at different pages of document 109 simultaneously all while in the same active video conference. However, in the instance of the attention tool, one participant 103 can mark a highlight location which will be distributed to the screens of the other participants 103. If the participant 103 (that receives the prompt from the highlighting participant 103) clicks on the link they cede partial control of their view of document 109 to participant 103 to jump to a particular location. So, although the viewing functions of document 109 are independent for each participant 103, there are at least some instances where the view of all participants 103 are linked. All of this is facilitated through system 10, and in particular combined integrated video document module 20 and

For example, as seen in FIG. 23, participant 103 “User 1” marked a spot of attention 211 on page (3) of the document, just beneath “section (13) “Miscellaneous”. The other participants receive a notification that participant 103 “User 1” marked a point of attention 211 as seen in FIG. 23.1, including a clickable link 212 that will take them to the exact spot on document 109 where “User 1” marked on the document 109. When link 212 is clicked by any one of participants 103, that participant 103 is immediately taken to the selected page and spot of attention 211. All this regarding the attention tool described in FIGS. 23 and 23.1 are integrated features that occur within the document signing functions and steps outlined above from FIGS. 2-22b.

The above screen shots demonstrate the present system 10 and method for providing a document signing feature 102 directly integrated in a video conference 101 without requiring any additional external applications. While in the document signing feature 102 each of the participants 103 remain actively engaged in the video conference 101 with the ability to to continue speaking with other participants 103 and live witness the signature process, as well as highlighting and reviewing document 109 in a collaborative manner. Document signing feature 102 is supported by integrated video session and document signing module 20 and is seamlessly integrated into an ongoing video conference 101 without the need to use external or independent document signing applications or software.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. A method for conducting a video conference, said method comprising the steps of:
providing a platform supporting a video conference between a plurality of participants, said plurality of participants engaging in a video conference thereon;
within said video conference, providing controls to at least one of said participants to upload a document to be signed, said uploaded document viewable by all of said participants, wherein each of said participants in said video conference may independently control their view of said document,
within said video conference, providing controls to said at least one participant that uploaded said document to be signed allowing said at least one participant to assign one or more participants as signatories of said document;
within said video conference, providing controls to at least said at least one participant that uploaded said document to be signed allowing said at least one participant to generate one or more markable locations on said uploaded document to be marked by said signatories;
providing controls to each of said participants assigned as signatories the ability to mark said document at at least one generated markable location;
providing controls to said at least one participant that uploaded said document to be signed to accept signatures of said participants assigned as signatories; and
providing controls to said at least one participant that uploaded said document to close said marked uploaded document and return all participants to said video conference.

2. The method as claimed in claim 1, wherein one or more markable locations on said uploaded document may include any one of initialing, dating, text entry, and signatures.

3. The method as claimed in claim 1, wherein said participants assigned as signatories have the ability to mark said document at all of said generated markable locations.

4. The method as claimed in claim 1, wherein said step of providing controls to said at least one participant that uploaded said document to be signed to accept signatures of said participants assigned as signatories; further comprises the step of providing controls to signatories to authenticate their markings.

5. The method as claimed in claim 4, wherein said step of providing controls to signatories to authenticate their markings includes providing the ability to authenticate that includes a photograph of said signatory.

6. The method as claimed in claim 4, further comprising the step of providing controls to said participant that uploaded said document to be signed to review and/or accept said markings and/or said authentications of said signatories.

7. The method as claimed in claim 1, further comprising the step of providing controls to said participant that uploaded said document to be signed to generate a signed document report, including activities and authentications of all signatories.

8. The method as claimed in claim 1, further comprising the step of providing controls to said participant that uploaded said document to be signed to close said document to be signed, allowing a view screen of the participants to resume in said video conference.

9. The method as claimed in claim 1, further comprising the step of providing an attention tool to one or more of said participants that permits said participants to mark a location on said uploaded document, said mark being alerted as a link to each of the remaining participants, such that if said link is activated by any one of said remaining participants, their view of the uploaded document is redirected to the marked location.

10. A system configured to conduct a video conference, said system comprising:
a platform supporting a video conference between a plurality of participants, said plurality of participants engaging in a video conference thereon;
said platform configured to support controls, within said video conference, provided to at least one of said participants to upload a document to be signed, said uploaded document viewable by all of said participants, wherein each of said participants in said video conference may independently control their view of said document,
said platform configured to support controls, within said video conference, provided to said at least one participant that uploaded said document to be signed allowing said at least one participant to assign one or more participants as signatories of said document;
said platform configured to support controls, within said video conference, provided to at least said at least one participant that uploaded said document to be signed allowing said at least one participant to generate one or more markable locations on said uploaded document to be marked by said signatories;
said platform configured to support controls for each of said participants assigned as signatories the ability to mark said document at at least one generated markable location;
said platform configured to support controls for said at least one participant that uploaded said document to be signed to accept signatures of said participants assigned as signatories; and
said platform configured to support controls for said at least one participant that uploaded said document to close said marked uploaded document and return all participants to said video conference.

11. The system as claimed in claim 10, wherein one or more markable locations on said uploaded document may include any one of initialing, dating, text entry, and signatures.

12. The system as claimed in claim 10, wherein said participants assigned as signatories have the ability to mark said document at all of said generated markable locations.

13. The system as claimed in claim 10, wherein said controls for said at least one participant that uploaded said document to be signed to accept signatures of said participants assigned as signatories; further include controls to signatories to authenticate their markings.

14. The system as claimed in claim 13, wherein said controls for signatories to authenticate their markings includes providing the ability to authenticate that includes a photograph of said signatory.

15. The system as claimed in claim 13, further comprising controls for said participant that uploaded said document to be signed to review and/or accept said markings and/or said authentications of said signatories.

16. The system as claimed in claim 10, further comprising controls for said participant that uploaded said document to be signed to generate a signed document report, including activities and authentications of all signatories.

17. The system as claimed in claim 10, further comprising controls for said participant that uploaded said document to be signed to close said document to be signed, allowing a view screen of the participants to resume in said video conference.

18. The system as claimed in claim 10, further comprising controls configured to enable an attention tool for one or more of said participants that permits said participants to mark a location on said uploaded document, said mark being alerted as a link to each of the remaining participants, such that if said link is activated by any one of said remaining participants, their view of the uploaded document is redirected to the marked location.
